(19) United States
(12) Patent Application Publication
(10) Pub. No.: US 2011/0059303 A1
(43) Pub. Date: Mar. 10, 2011

(54) Roofing Material

(76) Inventors: Ehrlich Gernot, Grafschaft-Gelsdorf (DE); Dan Harmony, Tucson, AZ (US)

(21) Appl. No.: 12/224,269

(22) PCT Filed: Feb. 22, 2006
(86) PCT No.: PCT/EP2007/051349

§ 371 Date: Nov. 17, 2010

(30) Foreign Application Priority Data
Feb. 22, 2006 (DE) 2020060029583

(51) Int. Cl. B32B 11/04; D03D 9/00; D04H 1/08; B32B 7/02

(52) U.S. Cl. 428/213; 428/489; 442/1; 428/292.1

(57) ABSTRACT

The present invention relates to a roofing material for covering a roof that can be coated or covered with a plurality of different roofing materials. The most currently used are pan tiles or roofing shingles which may be made from different materials such as clay, natural stone and from a carrier layer made of bitumen.

The present invention relates to a roofing material for covering a roof.

Roofs can be coated or covered with a plurality of different roofing materials. The most currently used are pan tiles or roofing shingles which may be made from different materials such as clay.

Usually, flat roofs are at first covered with roof sheeting (usually a sand covered roof sheeting V13, also tar paper). The roof sheeting is fastened to the underground with tar paper nails. Tar paper nails are short nails with a very wide head. Next, a bituminous felt is laid. Usually, this felt consists of a bituminous material. The underside of the bituminous felt is heated with a burner and welded to the underground. Next, a new layer of tar paper is laid, which covers the bituminous tar paper.

Pitched roofs by contrast are usually covered with roofing shingles or with pan tiles that are placed onto the roof truss. Underneath the pan tiles or the shingles there is provided what is referred to as a vapour pressure membrane which also seals the roof against water and moisture.

Bituminous shingles can be used as an alternative to clay or slate shingles for roofing. Bituminous shingles consist of a carrier layer made from glass fiber fleece, on either side of which there has been applied bitumen. The uppermost cover layer is a mineral granulate which may have different colors. Such type roofing is usually used for summer houses, tool sheds, vestibules or dormer and bay windows.

The main disadvantage of a roofing using pan tiles or shingles is at first the high price and the considerable expense for roofing. Another disadvantage when covering the roof only with bituminous felt or with tar paper is its unaesthetic appearance. This also applies mainly for roofing with bituminous shingles since they are also not very aesthetic because of their coating of mineral granulate when compared to a roofing with clay pan tiles.

The document DE 195 22 875 describes a flexible flat material that comprises at least one layer of a multilayered stone material and one flexible carrier layer of tensile strength. The multilayered coating of stone material is glued to the carrier layer with the help of an appropriate glue. The carrier layer is made from a synthetic resin. The described flat material is more specifically intended to be used for coating floors or furniture. The synthetic resin material forming the carrier layer is quite expensive and the flat material quite stiff. Insofar, the material is not suited for use as a roofing material; it is too expensive on the one side and on the other side it cannot be processed on a roof using conventional methods.

In the sense of the invention, the term roofing material is not strictly limited for use on a roof; it is also possible to utilize the material of the invention to sheath a façade or similar.

The object of the present invention consists in providing a roofing material that is fast and easy to lay and that is at a low cost to manufacture. Further, the roofing material must have an aesthetically pleasing appearance.

In accordance with the invention, the solution to this object is achieved by a roofing material that is formed from a surface layer made from natural stone and from a carrier layer made from bitumen.

According to the invention, there is provided a roofing material comprising at least one visible surface layer made from a natural stone such as slate, quartzite or the like. Accordingly, this surface layer is not made from a material imitation merely looking like a natural stone, but it is really made from the very natural stone. The carrier layer by contrast is made from bitumen which is flexible and has all the desired properties which are essential to a roofing material.

The carrier layer made from bitumen is solidly connected or glued to the surface layer made from natural stone. For this purpose, a thin layer of liquid bitumen is applied to a block of natural stone and is left to cool down. The bitumen thereby binds to the uppermost, very thin layer of the block. Once it has cooled down, the bitumen layer is removed from the block, with at least the uppermost layer of natural stone remaining glued to the bitumen. This is possible because the uppermost layer of the block forms a stronger bond with the bitumen than with the layers of natural stone materials lying underneath. When the bitumen layer is being removed, at least one layer of natural stone is also removed; sometimes several layers may keep adhering to the bitumen material.

Preferably, the roofing material additionally comprises a material exhibiting tensile strength which confers the required tensile strength to the roofing material. In a particularly advantageous implementation variant, a mesh of a material exhibiting appropriate tensile strength, for example a mesh of glass fiber plastic material, is integrated into the carrier layer. Such a mesh can also be disposed as a proper layer on the back side, meaning on the side of the carrier layer which is turned away from the surface layer.

A major advantage of the material is that it cannot be seen whether the roofing material is completely made from natural stone or not. Further, the roofing material has a low weight and is fast and easy to process. The important point is that there is no difference to those skilled in the art such as a roofer in processing the roofing material of the invention as compared to the hitherto used way of processing materials hitherto usual in commerce. Accordingly, the roofers will not have to change their working habits, which significantly increases acceptance of such a novel material.

As compared to a roofing material completely made from natural stone, the roofing material is of extremely low cost. Further, it can be brought into any shape. It can be envisaged to make the roofing material in the form of a roll that is unrolled on the roof and connected therewith. Alternatively, discrete shingles or pan tiles can be replicated and then mounted and welded one by one.

Finally, it is also possible to seal the roofing material with an appropriate layer. The seal may effect resistance to UV on the one side whilst on the other side it can prevent the quite thin surface layer from detaching from the carrier layer or from getting damaged.

The natural stone needed to manufacture the roofing material may either be provided in the form of a natural stone block but it may also be envisaged that such a block be formed so to say artificially by laminating several single layers together. These layers can then be stripped one after the other by bonding them to the mass of bitumen. Substantially, the manufacturing of the roofing material has been described in DE 195 22 875 A1 by the same inventor, this document being fully incorporated herein by reference.

The surface layer made from natural stone is significantly thinner than the carrier layer. The carrier layer is many times thicker than the surface layer. The carrier layer may for example have a thickness of about 2 to 4 mm, whereas the surface layer is only some few micrometers thick.

The invention will be explained in closer detail herein after with respect to the following Figs. In the drawing:

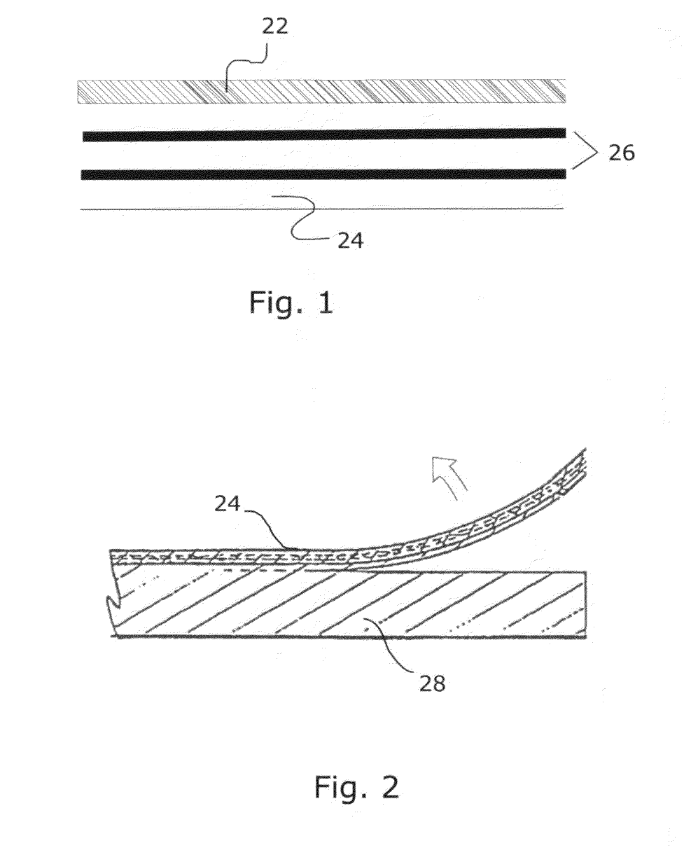

FIG. 1: shows the roofing material of the invention in a sectional view,

FIG. 2: shows a schematic diagram of the manufacturing of the roofing material.

FIG. 1 clearly shows that the roofing material 20 of the invention consists of a surface layer 22 and of a carrier layer 24. The surface layer 22 is made from a natural stone, the carrier layer 24 by contrast from bitumen.

Further, a material 26 exhibiting tensile strength is outlined in FIG. 1, said material ensuring the tensile strength of the roofing material 20. This material exhibiting tensile strength 26 is preferably formed from a mesh such as of glass fiber plastic material, which is embedded in the carrier layer 24.

FIG. 2 clearly shows how the roofing material 20 of the invention is formed. Bituminous material is heated and applied onto a block 28. After the bituminous material has cooled down, it is pulled away upward to later form the carrier layer 24 and pulls along with it a very thin layer of the block 28 which will later form the surface layer 22. This surface layer detaches from the block 28 and keeps adhering to the bitumen or to the carrier layer 24.

A mesh of material exhibiting tensile strength 26 can optionally be placed into the liquid bituminous material.

The invention is not limited to the described exemplary embodiment, but also extends to all the other embodiments which will be recognized upon getting to know the invention.

What is claimed:

1. A roofing material (20) formed from a surface layer (22) made of a natural stone and from a carrier layer (24) made of bitumen.

2. The roofing material (20) as set forth in claim 1, characterized in that a material (26) exhibiting tensile strength is further connected to the carrier layer (24).

3. The roofing material (20) as set forth in claim 1 or claim 2, characterized in that the material exhibiting tensile strength is formed from a mesh that is disposed inside the carrier layer (24).

4. The roofing material (20) as set forth in any one of the claims 1 through 3, characterized in that the carrier layer (24) is formed from bituminous felt.

5. The roofing material (20) as set forth in any one of the claims 1 through 4, characterized in that the roofing material (20) has the shape of shingles.

6. The roofing material (20) as set forth in any one of the claims 1 through 4, characterized in that the roofing material (20) is formed in webs and is implemented to be rolled into a roll.

7. The roofing material (20) as set forth in any one of the claims 1 through 6, characterized in that the carrier layer (24) is many times as thick as the surface layer (22).

8. The roofing material (20) as set forth in any one of the claims 1 through 7, characterized in that the carrier layer (24) has a thickness of about 2 to 4 mm and that the surface layer (22) has a thickness of a few micrometers.

9. The roofing material (20) as set forth in any one of the claims 1 through 8, characterized in that the surface layer (22) comprises a seal for protection against UV light.

10. The roofing material (20) as set forth in any one of the claims 1 through 9, characterized in that the surface layer (22) comprises a seal for protection against mechanical damage.
